(19) United States
(12) Patent Application Publication
(10) Pub. No.: US 2015/0369688 A1
(43) Pub. Date: Dec. 24, 2015

(54) MICROPHONE SEAL DETECTOR

(71) Applicant: Wistron Corporation, New Taipei City (TW)

(72) Inventor: Ian Lewis, Rolling Meadows, IL (US)

(21) Appl. No.: 14/308,823

(22) Filed: Jun. 19, 2014

(51) Int. Cl. G01M 3/00; G01N 29/09

(52) U.S. Cl. CPC G01M 3/007; G01N 29/09; G01N 2291/018; G01N 2291/0289

(57) ABSTRACT

A device, system and method for determining a seal quality of a sealed environment is provided herein. A seal detection device is utilized to determine a seal quality for an acoustic cavity of a microphone for a mobile device. The seal detection device determines an acoustic impedance at the end of a hollow longitudinal section by propagating a broadband audio signal from a source speaker through the hollow longitudinal section into the acoustic cavity. Located within the hollow longitudinal section is a microphone measurement portion configured to provide an output signal to measurement equipment in order to determine a transfer function between of the microphone measurement portion. Utilizing the transfer function, the seal quality can be determined for the acoustic cavity.

### FIELD OF THE INVENTION

This invention generally relates to audio quality test measurements for mobile devices, and more particularly to a seal quality measurement of a seal between a microphone and an acoustic port of the mobile device.

### BACKGROUND OF THE INVENTION

Typically, a mobile device such as a cellular phone includes a microphone configured to receive audio signals from a user of the mobile device. Generally, the microphone is adhered to a printed circuit board of the mobile device and oriented to receive the audio signal through an acoustic cavity formed between the printed circuit board and the housing. The acoustic cavity is exposed to the outside environment through a microphone port in the housing.

During a phone call, in order to prevent an echo effect being produced by the audio signal reflecting within the housing, a seal is provided between the housing and the printed circuit board to prevent acoustic signals present internally in the mobile device from entering the microphone. The seal should be substantially air tight such that any potential echo is minimized in the mobile device.

Historically, the frequency response of the mobile device microphone would be measured at three to five frequencies. A loudspeaker, placed within a quiet box to mimic a free field arrangement, generates a test audio signal, and test measurement equipment are connected to the microphone and typically configured to take measurements of microphone output at the three to five different frequencies. A problem with the seal is detected if that particular problem produces a measureable difference in the output of the microphone system at one or more of the particular frequencies chosen for the test. Therefore, the current test generally does not provide a complete picture of the state of the microphone seal.

Additionally, in order to take measurements from the microphone output during the historical test, the mobile device must be turned on so that the output from the microphone can be routed via the audio codec to external test equipment. Turning on the mobile device prior to performing the test is a time consuming process, which is not ideal for a manufacturing environment. Accordingly, it is typical to measure the microphone output at just a few frequencies to detect gross problems rather than to specifically test for seal quality of each mobile device being produced in the manufacturing environment.

In view of the above, there is a need for a device to enable an efficient measurement of seal quality over a broad bandwidth of frequencies, and further to enable an efficient measurement of seal quality over a broad bandwidth of frequencies in a manufacturing environment. Embodiments of the invention provide such a solution for measuring seal quality. These and other advantages of the invention, as well as additional inventive features, will be apparent from the description of the invention provided herein.

### BRIEF SUMMARY OF THE INVENTION

One embodiment provides a method of validating a seal utilizing a seal detection device coupled to measurement equipment, wherein calibration data from the seal detection device has been collected from the measurement equipment. The method includes applying an attachment portion of the seal detection device to a surface surrounding a port of a device under test. The method further includes acquiring measurement data by the measurement equipment, wherein the measurement data quantifies seal quality parameters. And the method includes determining a seal quality based on a difference between the measurement data and the calibration data.

Another embodiment provides a seal detection device for determining a seal quality for a device under test. The seal detection device includes a hollow longitudinal section, an attachment portion, a source speaker and a microphone measurement portion. The hollow longitudinal section includes a first distal end and a second distal end. The attachment portion is located at the first distal end and configured to form a substantially airtight seal between the hollow longitudinal section and a surface surrounding a port of the device under test. The source speaker is located at the second distal end and configured to project an audio signal into the hollow longitudinal section. And the microphone measurement portion is disposed within the hollow longitudinal section and configured to measure an acoustic impedance at the first distal end.

Yet another embodiment includes a seal quality measurement system for determining a seal quality in a manufacturing environment. The system includes a seal detection device, a testing station and a device under test. The seal detection device is configured to measure an acoustic impedance. The testing station includes measurement equipment configured to acquire measurement data from the seal detection device. And the device under test includes a printed circuit board (PCB), a housing, a microphone, a seal and an acoustic cavity. The PCB includes a microphone contact portion. The housing surrounds the PCB and includes an inner side wall, an outer side wall and a microphone port configured to provide access from the inner side wall to the outer side wall through the housing. The microphone is disposed on the microphone contact portion of the PCB and is configured to receive input through the microphone port of the housing. The seal forms a substantially air tight seal between the microphone and the housing. And the acoustic cavity is formed by the seal, the inner side wall of the housing and the microphone port.

Other aspects, objectives and advantages of the invention will become more apparent from the following detailed description when taken in conjunction with the accompanying drawings.

### BRIEF DESCRIPTION OF THE SEVERAL VIEWS OF THE DRAWING(S)

The accompanying drawings incorporated in and forming a part of the specification illustrate several aspects of the present invention and, together with the description, serve to explain the principles of the invention. In the drawings:

FIG. 1 is a cross-sectional view of a test setup configured to test a seal quality between a microphone and an acoustic cavity, according to an example embodiment;

FIG. 2 is a block diagram of a seal detection device, according to an example embodiment;

FIG. 3 is a cross-sectional view of the seal detection device, according to an example embodiment;

FIG. 4 is a flow chart of a calibration process for the seal detection device of FIG. 3, according to an example embodiment;

FIG. 5 is a flow chart of a seal quality measurement process for the test setup of FIG. 1, according to an example embodiment;

FIG. 6A is a plot obtained using the test set up of FIGS. 1 and 2 illustrating a low quality seal, according to an example embodiment; and

FIG. 6B is a plot obtained using the test set up of FIGS. 1 and 2 illustrating a high quality seal, according to an example embodiment.

### DETAILED DESCRIPTION OF THE INVENTION

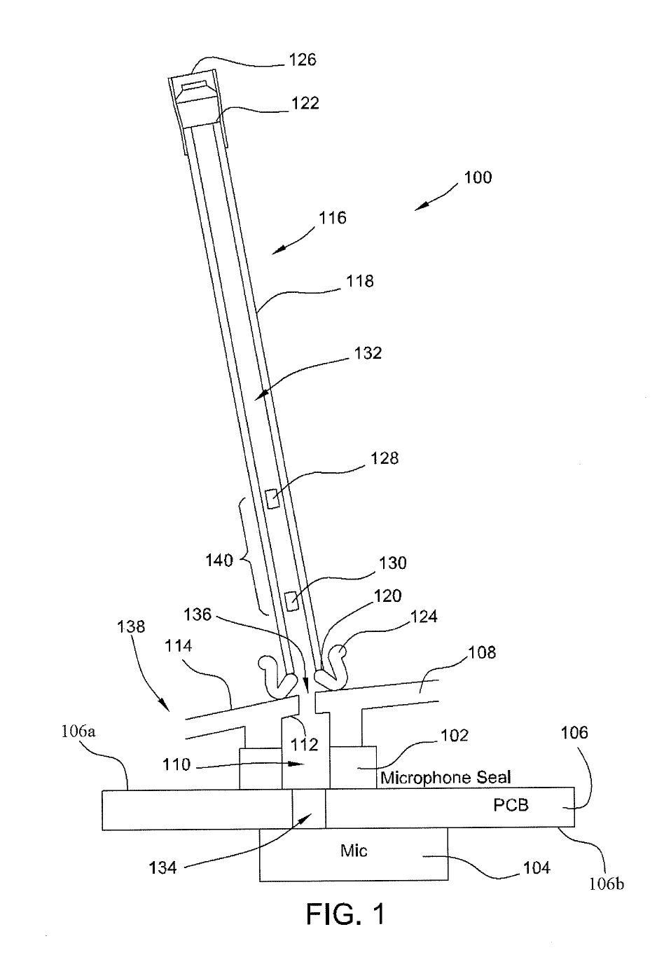

FIG. 1 illustrates a cross-sectional view of a test setup 100 configured to test a seal quality of a seal 102 between a microphone 104 and an acoustic cavity 110 of a mobile device 138. The purpose of the seal 102 is to prevent an audio signal entering the acoustic cavity 110 from a speaker (not illustrated) of the mobile device 138.

In the exemplary embodiment illustrated in FIG. 1, the acoustic cavity 110 is formed by a microphone port 136, an inner side wall 112 of a housing 108 of the mobile device 138, the seal 102 and a through-hole port 134 of a printed circuit board (PCB) 106 of the mobile device 138. The through-hole port 134 spans from a first side of the PCB 106a to a second side of the PCB 106b. An audio signal enters the acoustic cavity 110 through the microphone port 136 and is directed toward the microphone 104 for audio processing and transmission during use of the mobile device 138. In order to maintain a high quality audio experience for the user of the mobile device 138, the seal 102 should form a substantially air tight seal between the housing 108, the PCB 106 and the microphone 104. Also, as illustrated, the microphone 104 contacts the PCB 106 at a microphone contact portion on the second side of the PCB 106b, and in certain embodiments, this contact forms a substantially air-tight seal between the microphone 104 and the PCB 106. In doing so, any signals from an earpiece or loudspeaker of the mobile device 138 reaching the microphone 104 through the seal 102 will be limited.

FIG. 1 further illustrates a seal detection device 116 as part of the test setup 100. The seal detection device 116 is utilized to determine an acoustic impedance at the microphone port 136 of the mobile device 138. Indeed, certain measurement data obtained from measuring the acoustic impedance provides a gauge for seal quality of the seal 102.

The seal detection device 116 includes a hollow longitudinal section 118, which includes a first distal end 120 and a second distal end 122. In certain embodiments, the hollow longitudinal section 118 is substantially straight and tubular in shape. Attached at the first distal end 120 is an attachment portion 124, which, when pressed against a test surface, such as an outer side wall 114 of the housing 108 surrounding the microphone port 136, forms a substantially air tight seal between the attachment portion 124 and the surface. In certain embodiments, the attachment portion 124 is formed from a microcellular urethane such as PORON or any suitable soft rubber material such as silicone rubber or neoprene.

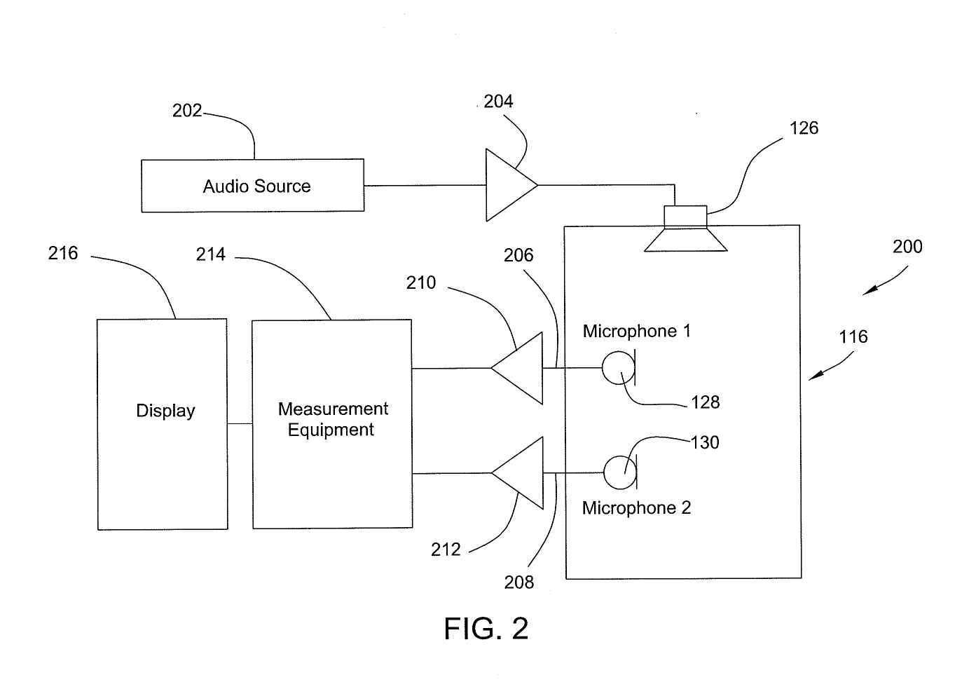

The seal detection device 116 further includes a microphone measurement portion 140 including a first microphone 128 and a second microphone 130. An output of the first microphone 128 and an output of the second microphone 130 are attached to measurement equipment (see FIG. 2) utilized to acquire measurement data utilized to determine a seal quality of the seal 102. As an aside, in certain embodiments, the microphone measurement portion 140 may include more than two microphones.

The seal detection device 116 further includes a source speaker 126 attached to the second distal end 122. The source speaker 126 is configured to transmit a broadband audio signal into the hollow longitudinal section 118 of the seal detection device 116. During transmission, the broadband audio signal proceeds from the second distal end 122 to the first distal end 120 of the hollow longitudinal section 118 and into the acoustic cavity 110 of the mobile device 138. During propagation of the broadband audio signal, the measurement equipment (see FIG. 2) collects measurement data from the output of the first microphone 128 and the output of the second microphone 130. This measurement data represents data collected regarding the broadband audio source and a reflection of the broadband audio source from the acoustic cavity 110 of the mobile device 138. This measurement data is utilized to determine seal quality parameters, which in turn are utilized to determine a seal quality.

The test setup 100 may generally be used in a manufacturing environment where the mobile device 138 is tested as a device under test. Seal quality for a plurality of devices under test would be determined by measuring a plurality of mobile devices. For each device under test, seal quality parameters would be collected and compared to calibration parameters, which represent an ideal seal condition. In certain embodiments, this comparison would result in a difference between the calibration parameters and the seal quality parameters that could be graphically depicted for each device under test in a histogram. In certain embodiments, a tolerance range would be developed such that any device under test where the difference between the seal quality parameters and the calibration parameters is outside of the tolerance range would be rejected as faulty, and any device under test where the difference between the seal quality parameters and the calibration parameters is inside of the tolerance range would pass the seal quality test as providing an acceptable user experience.

FIG. 2 illustrates a block diagram of an embodiment of the seal detection device 116 including components from a test setup 200 for determining seal quality. The test setup 200 further illustrates an audio source 202 that provides a broadband audio signal to an amplifier 204 that amplifies the broadband audio signal prior to being provided to the source speaker 126 of the seal detection device 116. The broadband audio signal typically includes a frequency range of 200 Hz-10 kHz.

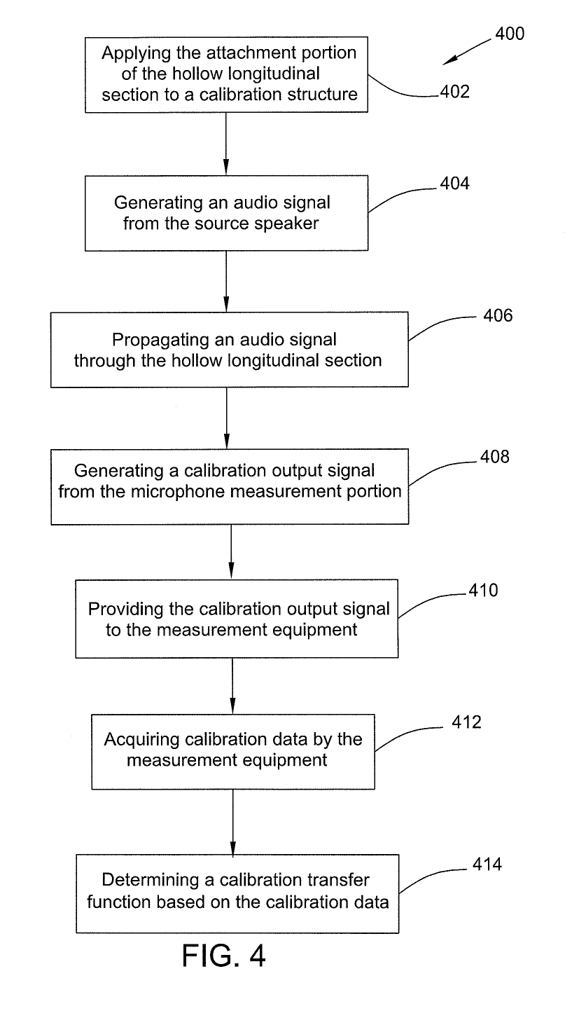

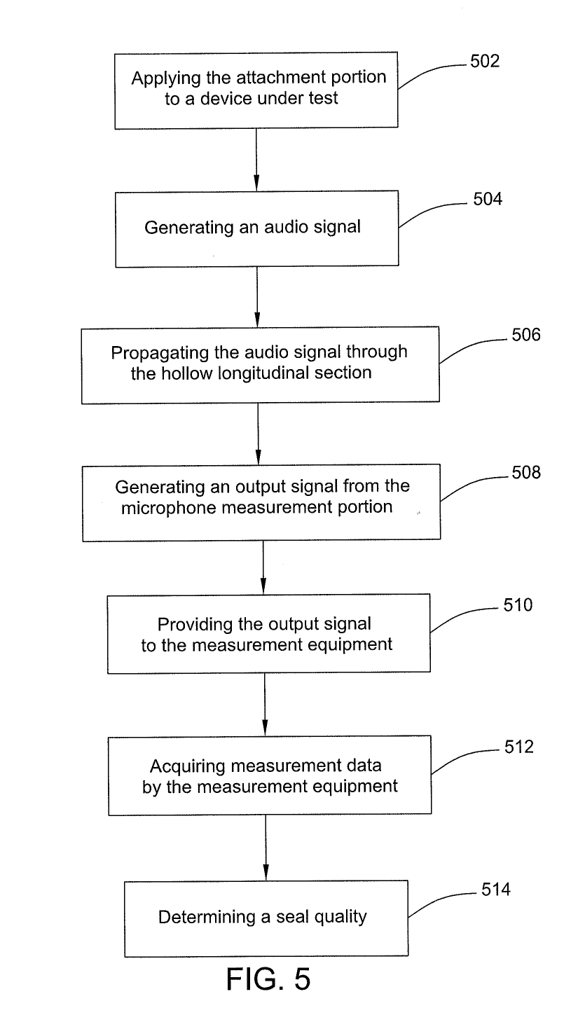

The test setup 200 also includes a testing station of the test setup including measurement equipment 214, which acquires output signals provided from the first and second microphones 128 and 130. The output signals contain measurement data from the seal detection device 116. In some embodiments, the output signals from the first and second microphones 128 and 130 are transmitted to amplifiers 210 and 212 over wired connections 206 and 208, respectively. Once the measurement equipment 214 acquires the measurement data contained in the output signals, the measurement equipment 214 performs signal processing to determine a transfer function H₁₂ between the first microphone 128 and the second microphone 130. To determine the transfer function, the measurement equipment 214 determines a fast Fourier transform (fft) using a window length based on the dimensions of the tube and spacing between the first and second microphones 128 and 130. Typically, the window frequency range is approximately 2 kHz-4 kHz. As discussed subsequently in FIGS. 4 and 5, the computed transfer function is then utilized to determine seal quality parameters by which the seal quality of the seal 102 (see FIG. 1) is determined. As an aside, the measurement equipment could be a spectrum analyzer, an audio analyzer, an oscilloscope, a logic analyzer or any device or processor capable performing the fft analysis over the relevant frequency range. In certain embodiments, the measurement equipment 214 may be a chip incorporated into the seal detection device 116.

In certain embodiments, the test setup 200 further includes a display 216. The display 216 may be any type of display that is capable of providing an indication to a user of the test setup 200 that a particular device under test has passed or failed the test. Accordingly, the display 216 may, in certain embodiments, be a cathode ray tube, liquid crystal display or any other type of display associated with the measurement equipment 214 and capable of providing visual indication of the seal quality parameters for determination of the seal quality. Further, the display 216 may be as simple as a light emitting diode (LED) that is activated when a device under test fails the test thereby indicating a poor seal quality or is activated when a device under test passes the test thereby indicating a high seal quality. In other embodiments, the display 216 could be a range of values representing a high or low seal quality with an indication needle that marks a value based on the measured transfer function and subsequent analysis of the seal quality parameters.

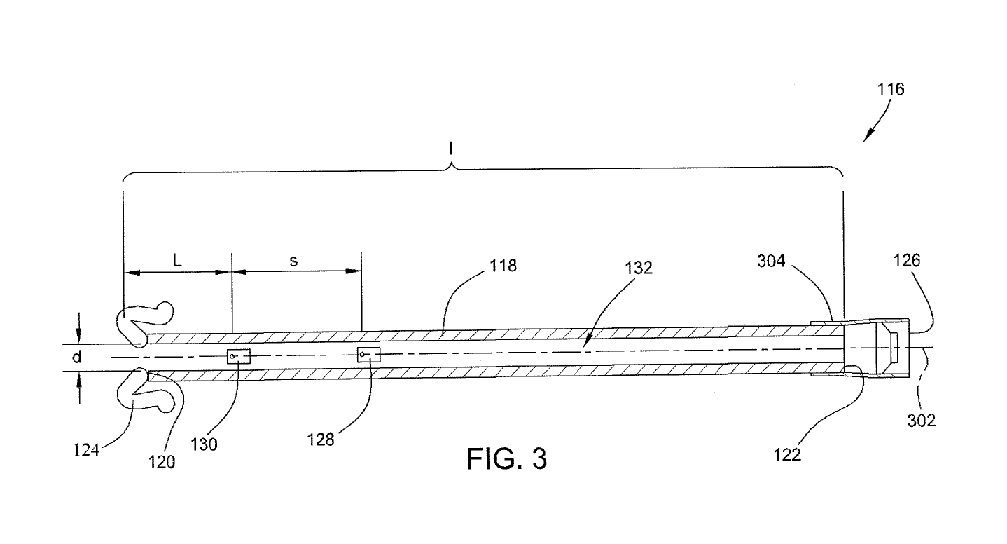

FIG. 3 illustrates a cross-sectional view of the seal detection device 116. As previously discussed, the seal detection device 116 includes the first distal end 120 and the second distal end 122. Attached to the seal detection device 116 at the first distal end 120 is the attachment portion 124, which is used to form a substantially air tight seal between the device under test and the seal detection device 116. The seal detection device 116 further includes the microphone measurement portion 140 including the first microphone 128 and the second microphone 130. Also, the seal detection device 116 includes the audio source 126, which is attached to the second distal end 122 by an attachment structure 304. The attachment structure 304 may be any structure that is capable of holding the audio source 126 in place such that the audio source 126 projects the broadband audio signal into a cavity 132 formed by the hollow longitudinal section 118. In certain embodiments, the attachment structure 304 could be a clip, a plastic support, a rubber sheath, an adhesive or tape.

In the embodiment of the seal detection device 116 illustrated in FIG. 3, the hollow longitudinal section 118 is substantially straight and tubular in shape. Extending through the center of the tube is a longitudinal axis 302, which indicates a center line through the hollow longitudinal section 118 of the seal detection device 116.

FIG. 3 illustrates additional dimensions of the seal detection device 116 such as a diameter d of the hollow longitudinal section 118, a length 1 of the hollow longitudinal section 118, a separation s that defines a distance between the first and second microphones 128 and 130 (arranged along the longitudinal axis 302) and a length L that defines a distance between the second microphone 130 and the first distal end 120. In certain embodiments, diameter d ranges in size from approximately 3-8 mm, length l of the hollow longitudinal section 118 ranges in length from approximately 80-130 mm, separation s ranges from approximately 15-25 mm and length L ranges from approximately 10-20 mm.

Each of these dimensions d, l, s and L affect the determination of the seal quality parameters utilized to determine the seal quality. Dimensions d and 1 are generally dimensions that affect transmission properties of the broadband audio signal as it propagates within the hollow longitudinal section 118, while dimensions L and s affect the determination of the transfer function between the first and second microphones 128 and 130 in relation to the acoustic cavity 110 (see FIG. 1) and an impedance Z at the first distal end 120. Indeed, the impedance Z is a function of a reflection coefficient R, which represents a magnitude of the broadband audio signal reflected back into the hollow longitudinal section 118 from the acoustic cavity 110. Equation (1) is utilized to determine the reflection coefficient R.

$$R = ( \frac{{H}_{12} - {e}^{- j ks}}{{e}^{j ks} - {H}_{12}} ) {e}^{j2k ( L + s )} \qquad ( 1 )$$

In equation (1), H₁₂ is a transfer function determined by the first microphone and the second microphone, k is 2*π*frequency/c, where c is the speed of sound, L is the length between the second microphone 130 and the first distal end 120 and s is the separation between the first and second microphones 128 and 130.

Using equation (1) to determine the reflection coefficient R, the acoustic impedance Z can be determined at the first distal end 120 using equation (2) below.

$$Z = ( \frac{1 + R}{1 - R} ) {ρ}_{o} c \qquad ( 2 )$$

In equation (2), Z is the acoustic impedance at the first distal end 120, ρₒ is the density of air, c is the speed of sound and R is the reflection coefficient determined by equation (1). In certain embodiments, the acoustic impedance Z, at the first distal end 120, may be one of the seal quality parameters because the acoustic impedance Z will be greatly affected by the seal quality of the seal 102 (see FIG. 1).

FIG. 4 illustrates a flow chart 400 of a calibration process for the seal detection device 116 of FIGS. 1, 2 and 3, according to an example embodiment. According to an embodiment of the disclosure, a seal quality can be determined by comparing the seal quality parameters as determined from the transfer function H₁₂ determined while measuring the seal quality in the acoustic cavity 110, as illustrated in FIG. 1, against a calibration transfer function. One method of determining a calibration transfer function requires measuring seal quality parameters with the first distal end 120 in a closed condition.

At step 402 of the flow chart 400, the seal detection device 116 is put into a closed condition. In the closed condition, the attachment portion 124 (see FIG. 1) of the first distal end 120 is applied to a calibration structure, such as a flat surface, such that a substantially air tight seal is formed between the calibration structure and the first distal end 120.

At step 404, the audio source 126 (see FIG. 1) generates an audio signal. As discussed previously, in certain embodiments, the audio signal is a broadband audio signal in the range from 200 Hz-10 kHz.

At step 406, the audio signal propagates through the hollow longitudinal section 118 (see FIG. 1) of the seal detection device 116. As the audio signal propagates through the hollow longitudinal section 118, the audio signal and reflections of the audio signal caused by the application of the calibration structure will be measured by the microphone measurement portion 140, which in certain embodiments includes the first and second microphones 128 and 130.

At step 408, the microphone measurement portion 140 (see FIG. 1) generates a calibration output signal. In certain embodiments, the calibration output signal includes an output of both of the first and second microphones 128 and 130 based on the audio signal and reflections of the audio signal. And, at step 410, the calibration output signal from the microphone measurement portion 140 is provided to the measurement equipment 214 (see FIG. 2). The calibration output signal contains calibration data utilized to perform the calibration of the seal detection device 116.

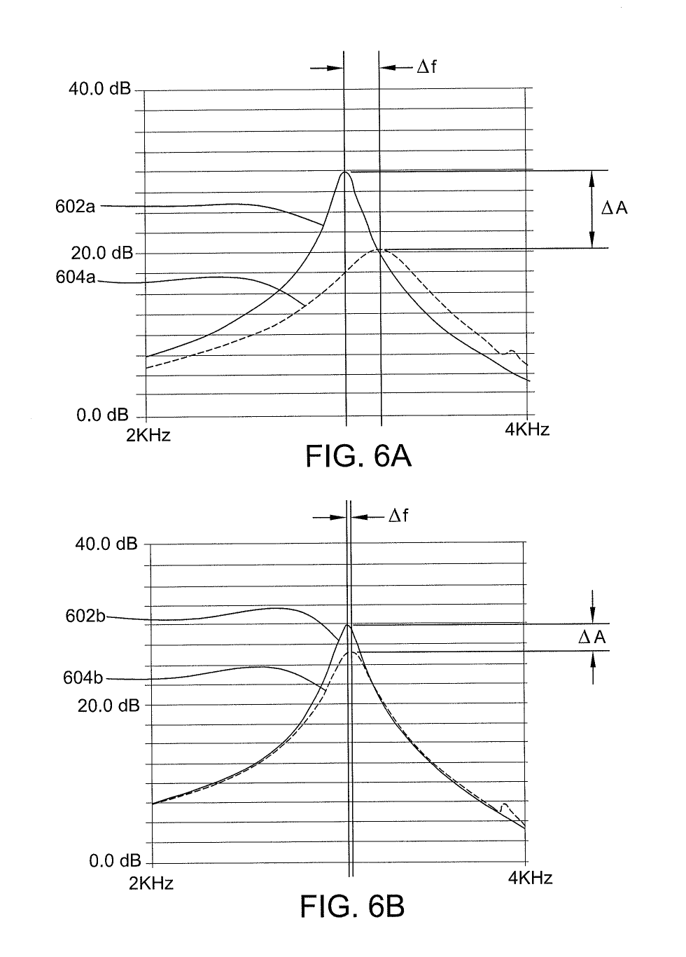

At step 412, the measurement equipment 214 (see FIG. 2) acquires the calibration data, and at step 414, the measurement equipment 214 performs an fft in order to determine the calibration transfer function. Utilizing the calibration transfer function calibration parameters can be determined and compared to seal quality parameters in order to perform a seal quality analysis, as described subsequently in reference to FIGS. 6A and 6B below.

As an aside, in certain embodiments, a further calibration measurement can be performed in a substantially similar fashion to that described above regarding FIG. 4. The further calibration measurement would be performing the same steps as above, but instead of the calibration structure terminating the first distal end 120 in a closed condition, the calibration structure would leave the first distal end 120 open. In the open condition, steps 404-414 may be performed in order to obtain an open calibration condition.

In certain embodiments, rather than the calibration structure putting the seal detection device 116 in a closed or open condition, the calibration structure may be a golden unit version of the device under test. For instance, in the embodiment illustrated in FIG. 1, where the device under test is a mobile device 138, a test mobile device 138 with a known high quality seal 102 could be utilized to obtain a base line transfer function, which would be used as the calibration transfer function, as discussed above. Subsequent devices under test would then be compared against the calibration transfer function obtained from the so called golden unit.

FIG. 5 illustrates a flow chart 500 of a seal quality measurement process for the test setup of FIG. 1, according to an example embodiment. At step 502, the attachment portion 124 of the first distal end 120 of the seal detection device 116 (see FIG. 1) is applied to the device under test. In the embodiment illustrated in FIG. 1, the device under test is a mobile device 138 with a microphone port 136 that provides access to the acoustic cavity 110.

At step 504, the audio source 126 (see FIG. 1) generates an audio signal. As discussed previously, in certain embodiments, the audio signal is a broadband audio signal in the range from 200 Hz-10 kHz.

At step 506, the audio signal propagates through the hollow longitudinal section 118 (see FIG. 1) of the seal detection device 116. As the audio signal propagates through the hollow longitudinal section 118, the audio signal and reflections of the audio signal caused by the interface with the microphone port 136 will be measured by the microphone measurement portion 140, which in certain embodiments includes the first and second microphones 128 and 130.

At step 508, the microphone measurement portion 140 (see FIG. 1) generates an output signal. In certain embodiments, the output signal includes an output of both of the first and second microphones 128 and 130 based on the audio signal and reflections of the audio signal. And, at step 510, the output signal from the microphone measurement portion 140 is provided to the measurement equipment 214 (see FIG. 2). The output signal contains measurement data utilized to determine the seal quality of the seal 102.

At step 512, the measurement equipment 214 (see FIG. 2) acquires the measurement data, and at step 514, the measurement equipment 214 performs an fft in order to determine the transfer function. Utilizing the transfer function H₁₂, seal quality parameters can be determined and compared to calibration parameters to determine a seal quality. This analysis is discussed further below in regards to FIGS. 6A and 6B.

FIGS. 6A and 6B illustrate curves 602 and 604 that represent transfer functions, where transfer function 602 represents a calibration transfer function and 604 represents the transfer function based on the measurement data. Specifically, curves 602a and 602b represent the calibration transfer function, and curves 604a and 604b represent a transfer function based on measurement data from a seal, such as seal 102 (see FIG. 1), of poor quality and a seal of high quality, respectively.

FIGS. 6A and 6B further illustrate the calibration and seal quality parameters used to determine the seal quality. Namely, a peak amplitude of curves 602 and 604 and a resonant frequency of curves 602 and 604. Once these parameters are collected, a difference between the peak amplitudes ΔA is determined between the peak amplitude of the calibration curve 602 and the peak amplitude of curve 604, representing the measurement data. Further, a difference between the resonant frequencies Δf is determined between the resonant frequency of the calibration curve 602 and the resonant frequency of curve 604, representing the measurement data.

Utilizing the determined ΔA and Δf, the seal quality can be determined. As shown in FIG. 6A, which represents a seal of poor quality, the ΔA between curve 602a and 604a is approximately 9.5 dB, and the Δf is approximately 130 Hz. As shown in FIG. 6B, which represents a seal of high quality, the ΔA between curve 602b and 604b is approximately 3 dB, and the Δf is approximately 10 Hz. In general, a ΔA of more than 3-6 dB and a Δf of more than 20-50 Hz indicate an issue with the seal quality of the device under test.

As an aside, the above values and discussion of determining a seal quality is made in reference to the seal 102 (see FIG. 1) of the acoustic cavity 110 of the mobile device 138. However, the disclosure contained herein relates more generally to any structure where an acoustic impedance measurement, as discussed above, may be used to determine an efficacy of a sealed environment. For instance, in certain embodiments and in view of the disclosure contained herein, the devices such as the seal detection device 116 and measurement methods could be adapted to determine whether mining equipment is properly sealed so as to avoid an electrical spark within the equipment igniting gases within the mining environment. Additionally, in the medical devices sector, certain devices must be sealed in order to avoid contact with an outside environment. Accordingly, in other embodiments of the devices and methods discussed herein, the devices, systems and methods could be adapted to determine whether these devices in the medical devices sector are properly sealed. Even further, in other embodiments, the seal detection device 116 could be further adapted for use in tympanometry, which is a measure of the mechanical impedance of the bones of the middle ear.

Furthermore, the seal detection device 116 could be further adapted to test the seal of a loud speaker, such as a loud speaker of a typical mobile device. In this embodiment, the source speaker 126 would be configured to drive the loud speaker at or near the loud speaker's resonant frequency.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of validating a seal utilizing a seal detection device coupled to measurement equipment, wherein calibration data from the seal detection device has been collected from the measurement equipment, the method comprising:
applying an attachment portion of the seal detection device to a surface surrounding a port of a device under test;
acquiring measurement data by the measurement equipment, wherein the measurement data quantifies seal quality parameters; and
determining a seal quality based on a difference between the measurement data and the calibration data.

2. The method of claim 1, wherein the seal detection device comprises:
a hollow longitudinal section including a first distal end and a second distal end and the attachment portion is connected to the first distal end;
a source speaker connected to the second distal end and configured to propagate a broadband audio signal into the hollow longitudinal section; and
a microphone measurement portion disposed within the hollow longitudinal section.

3. The method of claim 2, wherein after the step of applying the attachment portion, the method further comprises:
generating the broadband audio signal by the source speaker;
propagating the broadband audio signal through the hollow longitudinal section;
generating an output signal from the microphone measurement portion based on the broadband audio signal; and
providing the output signal to the measurement equipment.

4. The method of claim 3, further comprising determining a transfer function based on the output signal from the microphone measurement portion, wherein the transfer function determines the seal quality parameters.

5. The method of claim 4, wherein the seal quality parameters comprise a resonant frequency and a peak amplitude of the transfer function at the resonant frequency.

6. The method of claim 5, wherein the calibration data is determined during a calibration process, the calibration process comprises:
applying the attachment portion of the seal detection device to a calibration structure;
generating the broadband audio signal by the source speaker;
propagating the broadband audio signal through the hollow longitudinal section;
generating a calibration output signal from the microphone measurement portion based on the broadband audio signal;
providing the calibration output signal to the measurement equipment;
acquiring calibration data by the measurement equipment; and
determining a calibration transfer function based on the calibration output signal from the microphone measurement portion, wherein the calibration transfer function determines calibration parameters including a calibration resonant frequency and a calibration peak amplitude of the calibration transfer function at the calibration resonant frequency.

7. The method of claim 6, wherein determining a seal quality based on a difference between the measurement data and the calibration data comprises:
determining a frequency difference between the resonant frequency and the calibration resonant frequency; and
determining an amplitude difference between the peak amplitude and the calibration peak amplitude.

8. The method of claim 7, further comprising determining a seal failure if the frequency difference between the resonant frequency and the calibration resonant frequency is greater than 20 Hz and the amplitude difference between the peak amplitude and the calibration peak amplitude is greater than 3 dB.

9. The method of claim 7, further comprising determining a seal failure if the frequency difference between the resonant frequency and the calibration resonant frequency is greater than 50 Hz and the amplitude difference between the peak amplitude and the calibration peak amplitude is greater than 6 dB.

10. A seal detection device for determining a seal quality for a device under test, the seal detection device comprising:
a hollow longitudinal section including a first distal end and a second distal end;
an attachment portion located at the first distal end and configured to form a substantially airtight seal between the hollow longitudinal section and a surface surrounding a microphone port of the device under test;
a source speaker located at the second distal end and configured to project an audio signal into the hollow longitudinal section; and
a microphone measurement portion disposed within the hollow longitudinal section and configured to measure an acoustic impedance at the first distal end.

11. The device of claim 10, wherein the microphone measurement portion comprises a first microphone and a second microphone separated by a first distance along a longitudinal axis spanning through a cavity formed by the hollow longitudinal section.

12. The device of claim 11, wherein the first microphone and the second microphone are located along the longitudinal axis with the second microphone closer to the first distal end than the first microphone and the second microphone is separated along the longitudinal axis from the first distal end by a second distance.

13. The device of claim 12, wherein the acoustic impedance is determined by
$$Z = ( \frac{1 + R}{1 - R} ) {ρ}_{o} c$$
where Z is the acoustic impedance, ρₒ is the density of air, c is the speed of sound and R is a reflection coefficient determined by
$$R = ( \frac{{H}_{12} - {e}^{- j ks}}{{e}^{j ks} - {H}_{12}} ) {e}^{j2k ( L + s )}$$
where H₁₂ is a transfer function determined by the first microphone and the second microphone, k is 2*π*frequency/c, L is the first distance and s is the second distance.

14. The device of claim 13, wherein s is approximately 15 to 25 mm and L is approximately 10 to 20 mm.

15. The device of claim 10, wherein the hollow longitudinal section is a tube with a diameter ranging approximately from 3 to 8 mm and a length ranging from approximately 80 to 130 mm.

16. The device of claim 10, wherein the audio signal is a broadband audio signal with a frequency ranging approximately from 200 Hz to 10 kHz.

17. A seal quality measurement system for determining a seal quality, the system comprising:
a seal detection device configured to measure an acoustic impedance;
a testing station including measurement equipment configured to acquire measurement data from the seal detection device; and
a device under test comprising:
a printed circuit board (PCB) including a microphone contact portion;
a housing surrounding the PCB and including an inner side wall, an outer side wall and a microphone port configured to provide access from the inner side wall to the outer side wall through the housing;
a microphone disposed on the microphone contact portion of the PCB and configured to receive input through the microphone port of the housing;
a seal forming a substantially air tight seal between the microphone and the housing; and
an acoustic cavity formed by the seal, the inner side wall of the housing and the microphone port.

18. The system of claim 17, wherein the seal detection device comprises:
a hollow longitudinal section including a first distal end and a second distal end;
an attachment portion located at the first distal end and configured to form a substantially airtight seal between the hollow longitudinal section and a portion of the outer side wall of the housing surrounding the microphone port of the device under test;
a source speaker located at the second distal end and configured to project an audio signal into the hollow longitudinal section; and
a microphone measurement portion disposed within the hollow longitudinal section and configured to measure an acoustic impedance at the first distal end.

19. The system of claim 18, wherein the microphone measurement portion comprises a first microphone and a second microphone separated by a first distance along a longitudinal axis spanning through a cavity formed by the hollow longitudinal section.

20. The system of claim 19, wherein the hollow longitudinal section is a tube with a diameter ranging approximately from 3 to 8 mm and a length ranging from approximately 80 to 130 mm.

21. A seal detection device for determining a seal quality of a cavity partially formed by a seal, the seal detection device comprising:
a hollow longitudinal section including a first end;
an attachment portion located at the first end and configured to attach to a port of the cavity;
a source speaker configured to project an audio signal into the hollow longitudinal section; and
a microphone measurement portion disposed within the hollow longitudinal section and configured to measure an acoustic impedance of the cavity at the first end.

22. The device of claim 21, wherein the microphone measurement portion comprises a first microphone and a second microphone separated by a first distance along a longitudinal axis spanning through a cavity formed by the hollow longitudinal section.
